(19) United States
(12) Patent Application Publication
(10) Pub. No.: US 2003/0047128 A1
(43) Pub. Date: Mar. 13, 2003

(54) In-line flow indicator assembly

(76) Inventor: Terrence E. Delp, Columbus, OH (US)

Correspondence Address: Thomas S. Baker, Jr., 1371 West 3rd Avenue, Columbus, OH, 43212, US

(21) Appl. No.: 09/948,359

(22) Filed: Sep. 7, 2001

(51) Int. Cl. G01F 15/06

(52) U.S. Cl. 116/276

(57) ABSTRACT

A novel in-line flow indicator assembly is provided with a fitting body having oppositely positioned wall window openings, a sight glass tube positioned within the fitting body, end caps co-operating with the fitting body to contain the sight glass tube in position, and conventional O-rings that function to seal the assembly through fluid passageway and to resiliently position the sight glass tube within the fitting body.

### CROSS-REFERENCES

None.

### FIELD OF THE INVENTION

The instant invention relates generally to fluid flow systems, and particularly concerns a visual flow indicator assembly which has the form of a in-line fitting that may be readily repaired or modified to be adaptable to installation in different fluid flow line applications.

### SUMMARY OF THE INVENTION

The novel in-line flow indicator assembly of the present invention is essentially comprised of a fitting body element having oppositely positioned wall window openings, a sight glass tube element positioned within the fitting body element, a pair of end cap elements co-operating with the fitting body to contain the sight glass tube in position, a pair of conventional O-ring elements that function to seal the assembly through fluid passageway, and another pair of conventional O-ring elements that function to position the sight glass tube element resiliently within the fitting body element.

### BRIEF DESCRIPTION OF THE DRAWINGS

FIG. 1 is an isometric view of a preferred embodiment of the invention disclosed and claimed in this patent application.

FIG. 2 is an exploded view of the invention assembly illustrated in FIG. 1; and

FIG. 3 is a section view taken at line 3-3 of FIG. 1.

### DETAILED DESCRIPTION

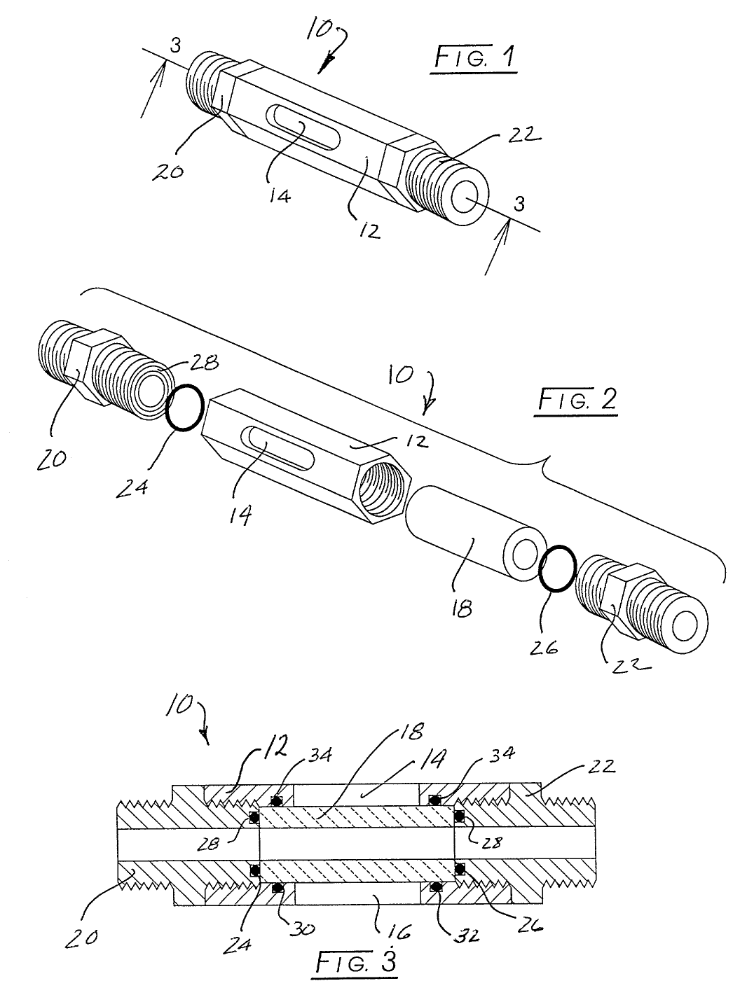

Referring to FIGS. 1 through 3, a preferred embodiment of the instant invention is referenced by the numeral 10, and is essentially comprised of a generally tubular, fitting body element 12 having oppositely positioned wall window openings 14 and 16, an internally located transparent sight glass tube element 18, and threaded fitting body end cap elements 20 and 22. Fitting assembly 10 is further comprised of conventional elastomeric O-ring end-seal elements 24 and 26 which each co-operate with a groove 28 provided in its respectively adjacent fitting body end cap element, and of conventional elastomeric O-ring spacer elements 30 and 32 which each co-operate with a respective annular groove 34 provided in fitting body element 12. Components 12, 20, and 22 are preferably fabricated from either conventional stainless steel alloys such as Types 304 and 316 stainless steel or from high-strength carbon steel alloy materials.

When components 12 through 34 are properly assembled to comprise flow indicator assembly 10, seal elements 24 and 26 are compressed between the end surfaces of sight glass tube element 18 and end cap elements 20 and 22, respectively, by axial or longitudinally-oriented compressive forces arising out of the complete meshing of threaded end cap elements 20 and 22 with the co-operating internally threaded ends of fitting body element 12. Similarly, spacer elements 30 and 32 are compressed between sight glass tube elements 18 and fitting body element 12, but by radial compressive forces arising out of the insertion of tube element 18 in a properly sized internal bore provided in fitting body element 12—the diameter of such internal bore being slightly larger than the external diameter of sight glass tube element 18.

Various changes may be made to the configuration, relative size, and material of construction of each element of the above-disclosed invention without departing from the meaning, scope, or intent of the claim which follows.

I claim my invention as follows:

1. In an in-line flow indicator assembly, comprised of:
a fitting body element having an internal bore and oppositely positioned wall window openings;
a transparent sight glass tube element positioned internally of said fitting body element internal bore;
a pair of fitting body end cap elements each co-operating with a respective end of said fitting body element;
a pair of O-ring seal elements; and
a pair of O-ring spacer elements,
said pair of O-ring seal elements being compressed by longitudinal compressive forces existing between said sight glass tube element and said pair of fitting body end cap elements, and said pair of O-ring spacer elements being compressed by radial compression forces existing between said sight glass tube element and said fitting body element.
